(19) United States
(12) Patent Application Publication
(10) Pub. No.: US 2018/0079622 A1
(43) Pub. Date: Mar. 22, 2018

(54) ELEVATOR TESTING ARRANGEMENT

(71) Applicant: Otis Elevator Company, Farmington, CT (US)

(72) Inventors: Gerard Sirigu, Gien (FR); Nicolas Fonteneau, Chateauneuf Sur Loire (FR); Gregor Stricker, Berlin (DE); Alexander Paetow, Berlin (DE); Javier Garcia-Casla, Madrid (ES); Ricardo Cano-Torres, Madrid (ES); Gianluca Foschini, Madrid (ES); Helmut Lothar Schroeder-Brumloop, Berlin (DE)

(21) Appl. No.: 15/560,069

(22) PCT Filed: Mar. 20, 2015
(86) PCT No.: PCT/EP2015/055983

§ 371 Date: Sep. 20, 2017

(51) Int. Cl. B66B 5/00; B66B 13/22

(52) U.S. Cl. CPC B66B 5/0093; B66B 9/00; B66B 13/22; B66B 5/0031

(57) ABSTRACT

A testing arrangement (36) for testing the operability of at least one safety sensor (21, 22, 23, 26, 28) connected to the safety chain (30) of an elevator system (1), the testing arrangement (36) comprises: at least one test circuit (34) for testing the operability of the at least one safety sensor (21, 22, 23, 26, 28); and at least one testing relay (32, 33). The testing relay (32, 33) is switchable between an operational position and a test position and it is configured for electrically connecting the at least one safety sensor (21, 22, 23, 26, 28) to the safety chain (30) in the operational position and for electrically connecting the at least one safety sensor (21, 22, 23, 26, 28) to the test circuit (34) in the test position.

The invention relates to a testing arrangement for testing the operability of at least one safety switch which is connected to an elevator system's safety chain.

In order to allow for safe operation every elevator system comprises a safety chain including a plurality of safety sensors, in particular safety switches. The operation of the elevator system is stopped or not even started when at least one of the safety sensors reports a malfunction, e.g. when at least one of the safety switches is not correctly closed.

In order to ensure safe operation of the elevator system, the safety sensors of the safety chain need to be regularly checked. It therefore is desirable to provide a testing arrangement which allows for automatically testing the safety sensors of an elevator system's safety chain without compromising the integrity of the safety chain.

An exemplary embodiment of such a testing arrangement for testing the operability of at least one safety sensor, which is connected to a safety chain of an elevator system, comprises: at least one test circuit for testing the operability of the at least one safety sensor and at least one testing relay being switchable between an operational position and a test position. The testing relay is configured for electrically connecting the at least one safety sensor to the safety chain when positioned in the operational position and for electrically connecting the at least one safety sensor to the test circuit when positioned in the test position.

An exemplary embodiment of an elevator safety system according to an exemplary embodiment of the invention comprises a safety chain including at least one safety sensor and a testing arrangement according to an exemplary embodiment of the invention.

A method for testing the operability of at least one safety sensor in a safety chain of an elevator system according to an exemplary embodiment of the invention comprises the steps of electrically disconnecting the at least one safety sensor from the safety chain and electrically connecting the at least one safety sensor to an electrical test circuit which is configured to testing the operability of the safety sensor.

By disconnecting the at least one safety sensor from the safety chain and electrically connecting the at least one safety sensor to a test circuit the operability of the safety sensor may be tested automatically and reliably without compromising the integrity of the safety chain. In particular, no additional circuitry needs to be added to the safety chain. The arrangement and method for testing the safety sensor(s) of the safety chain according to exemplary embodiments of the invention are in particular in agreement with actual safety standards, in particular EN-81.20.

Exemplary embodiments of the invention will be described in the following with reference to the enclosed figures.

### SHORT DESCRIPTION OF THE FIGURES

FIG. 1 shows a schematic illustration of an elevator system in which embodiments of the invention may be employed.

FIG. 2a illustrates a first exemplary embodiment of a testing arrangement in its operational state.

FIG. 2b illustrates the first exemplary embodiment of a testing arrangement in its testing state.

FIG. 3a illustrates a second exemplary embodiment of a testing arrangement in its operational state.

FIG. 3b illustrates the second exemplary embodiment of a testing arrangement in its testing state.

FIG. 4a illustrates a third exemplary embodiment of a testing arrangement in its operational state.

FIG. 4b illustrates the third exemplary embodiment of a testing arrangement in its testing state.

FIG. 5a illustrates a fourth exemplary embodiment of a testing arrangement in its operational state.

FIG. 5b illustrates the fourth exemplary embodiment of a testing arrangement in its testing state.

### DETAILED DESCRIPTION OF THE FIGURES

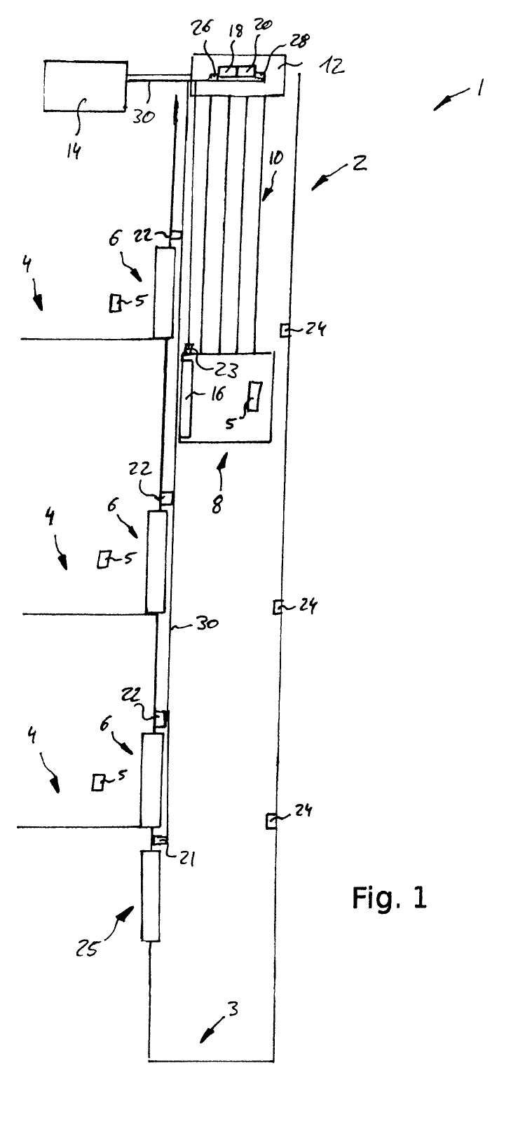

FIG. 1 shows a schematic illustration of an elevator system 1 in which exemplary embodiments of the invention may be employed. The elevator system 1 shown in FIG. 1 comprises a hoistway 2 extending between a plurality of floors 4. At least one hoistway door 6 is provided at each floor 4 allowing access to the hoistway 2 from the floor 4.

An elevator car 8 is suspended by means of at least one tension member 10 within the hoistway 2, the tension member 10 being mechanically connected to an elevator drive 12 provided at the top of the hoistway 2 allowing to move the elevator car 8 along the longitudinal extension of the hoistway 2 between the plurality of floors 4 by operating the elevator drive 12.

The elevator drive 12 comprises a motor 18 for moving the elevator car 8 and a brake for preventing any movement of the elevator car 8 when it is located at one of the floors 4. The motor 18 and the brake 20 are respectively associated with an associated safety sensor, i.e. a motor sensor 26 and a brake sensor 28, which are configured for monitoring the operation of the motor 18 and the brake 20, respectively.

The elevator drive 12 may be located in any other portion of the hoistway, e.g. in a pit 3 at the bottom of the hoistway or even mounted on the elevator car 8 itself. It also may be located in a separate machine room, which is not shown in FIG. 1. The elevator system 1 may have or may not have a counterweight, which is not shown in FIG. 1. At least one maintenance door 25 may provide access to the hoistway 2 and/or the machine room (not shown).

The elevator car 8 comprises at least one elevator car door 16, which is located opposite to a corresponding hoistway door 6 when the elevator car 8 is positioned at a specific floor 4. The car door 16 and the corresponding hoistway door 6 open in coordination with each other in order to allow passengers to transfer between the elevator car 8 and the respective floor 4.

The elevator drive 12 is functionally connected to an elevator control unit 14 controlling the movement of the elevator car 8 and the opening and closing of the doors 6, 16, 25.

A plurality of input units 5 are provided at each of the floors 4 and/or within the elevator car 8. The input units 5 are connected by wires (not shown) or by a wireless connection to the elevator control unit 14 in order to allow passengers to input control commands causing the elevator drive 12 to move the elevator car 8 to a desired floor 4.

For ensuring safe operation of the elevator system 1, it is desirable to closely monitor the movement of the doors 6, 16, 25 in particular to make sure that all doors 6, 16, 25 are correctly closed before the elevator car 8 is moved, in order to prevent passengers from falling into the hoistway and/or getting trapped between the floor 4 and the moving elevator car 8.

Thus, at least one safety sensor, which is provided in the form of a safety switch 21, 22, 23, in particular a car door switch 23, a landing door switch 22 or a maintenance door switch 21, is provided at each of the doors 6, 16, 25. The safety switches 21, 22, 23 are configured for monitoring the movement of the respective door 6, 16, 25 and in particular for detecting whether the respective door 6, 16, 25 is correctly closed.

Additional positional sensors 24, which are configured for detecting whether the elevator car 8 is correctly positioned at a specific floor 4, may be provided within the hoistway 2, as well.

The safety switches 21, 22, 23, the motor sensor 26 and the brake sensor 28 are functionally connected to the elevator control unit 14 by means of a safety chain 30 which is configured for preventing any movement of the elevator car 8 in case any of the safety switches 21, 22, 23 reports an open (not completely closed) door 6, 16 or any of the sensors 26, 28 reports a malfunction of the motor 18 or the brake 20, respectively.

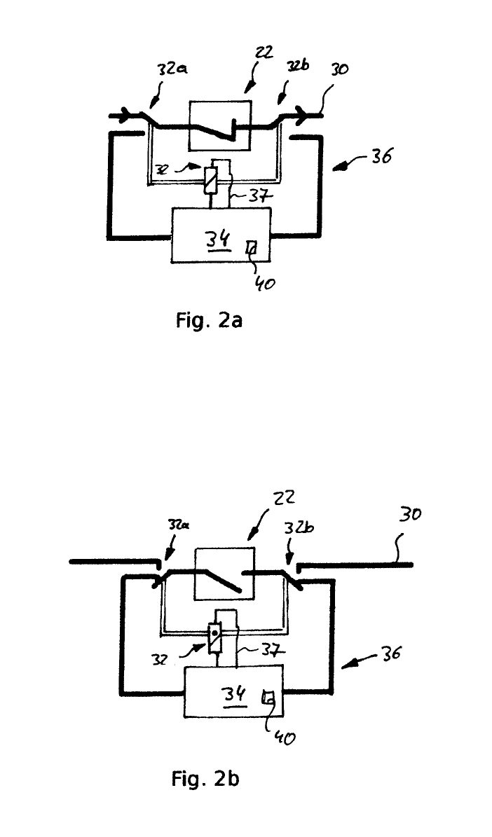

FIGS. 2a and 2b illustrate an exemplary embodiment of a testing arrangement 36 for testing the operability of at least one safety switch 22 electrically connected to the safety chain 30 of the elevator system 1. The testing arrangement 36 includes a test circuit 34 which is configured for testing the operability of the at least one safety switch 22 and at least one testing relay 32 comprising at least two sets of contacts 32a, 32b. In the exemplary embodiments shown in these and the following figures the test circuit 34 comprises a microprocessor 40 which is configured for running an appropriate test program for testing the operability of the at least one safety switch 22, 23 electrically connected to the test circuit 34.

The testing relay 32 is switchable between an operational position illustrated in FIG. 2a, in which the safety switch 22 is electrically connected to the safety chain 30, and a test position illustrated in FIG. 2b, in which the safety switch 22 is disconnected from the safety chain 30 and electrically connected to the test circuit 34. The test circuit 34 and in particular the microprocessor 40 may be configured for driving the testing relay 32 to switch between these two positions by means of electrical lines 37 connecting the testing relay 32 with the test circuit 34.

Disconnecting the safety switch 22 from the safety chain 30 and electrically connecting it to the test circuit 34 allows testing the functionality of the safety switch 22 without adding electrical circuitry to the safety chain 30. The safety chain 30 is interrupted when the testing relay 32 is switched into the test position. Thus, the testing of the safety switch 22 preferably is performed when the elevator car 8 is stopped at one of the floors 4.

In order to ensure a reliable operation of the elevator system 1, the testing relay 32 preferably is provided as a security relay comprising positively driven contacts 32a, 32b, i.e. contacts 32a, 32b which are automatically driven into the operational position shown in FIG. 2a in case the testing relay 32 is not powered.

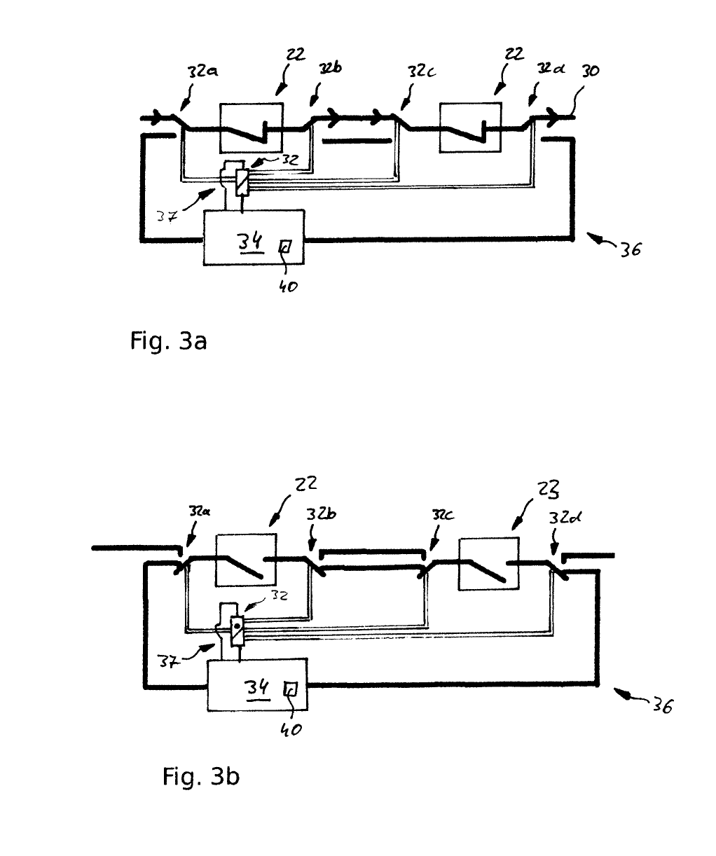

FIGS. 3a and 3b illustrates a second exemplary embodiment of a testing arrangement 36, in which a plurality of safety switches 22, 23, which are serially connected within the safety chain 30 in the operational state, are simultaneously disconnected from the safety chain 30 and electrically connected to the test circuit 34 by means of a single testing relay 32 comprising a plurality, in particular four, sets of contacts 32a, 32b, 32c, 32d. Although only two safety switches 22, 23 and four sets of contacts 32a, 32b, 32c, 32d are shown in the figures, the skilled person will easily understand that the principle shown in these figures may be extended to a plurality of safety sensors including any number of safety switches 21, 22, 23, motor sensors 26 and brake sensors 28.

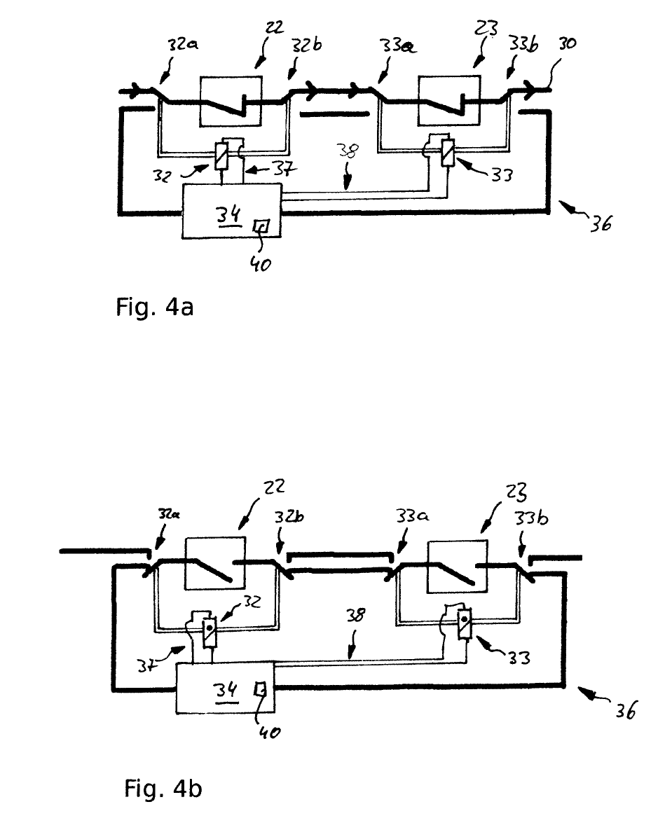

In a third embodiment of a testing arrangement 36, as it is illustrated in FIGS. 4a and 4b, instead of using a single testing relay 32 comprising a plurality of contact pairs 32a, 32b, 32c, 32d, as it is employed in the second embodiment of a testing arrangement 36 shown in FIGS. 3a and 3b, an individual testing relay 32, 33 respectively comprising two sets of contacts 32a, 32b, 33a, 33b is associated with each of the safety switches 22, 23, respectively.

In said third embodiment of a testing arrangement 36 each testing relay 32, 33 is individually connected to the testing circuit 34 by corresponding electrical lines 37, 38. Usually all testing relays 32, 33 are driven simultaneously for simultaneously disconnecting the safety switches 22, 23 from the safety chain 30 and electrically connecting the safety switches 22, 23 to the testing circuit 34 (FIG. 4a) and vice versa (FIG. 4b).

In the embodiments shown in FIGS. 3a, 3b, 4a, and 4b the safety switches 22, 23 are serially connected to the testing circuit 34 when the at least one testing relay 32, 33 is switched to the testing mode. Such a serial connection allows only for simultaneously testing the safety switches 22, 23. Thus, with the configurations of testing arrangements 36 shown in FIGS. 3a, 3b, 4a, and 4b, it is possible to detect a situation in which at least one safety switch 22, 23 does not operate correctly; however, as the safety switches 22, 23 are serially connected to the testing circuit 34 in the test mode, as shown in FIGS. 3b and 4b, it is not possible to automatically uniquely identify a defect safety switch 22, 23 from the plurality of safety switches 22, 23.

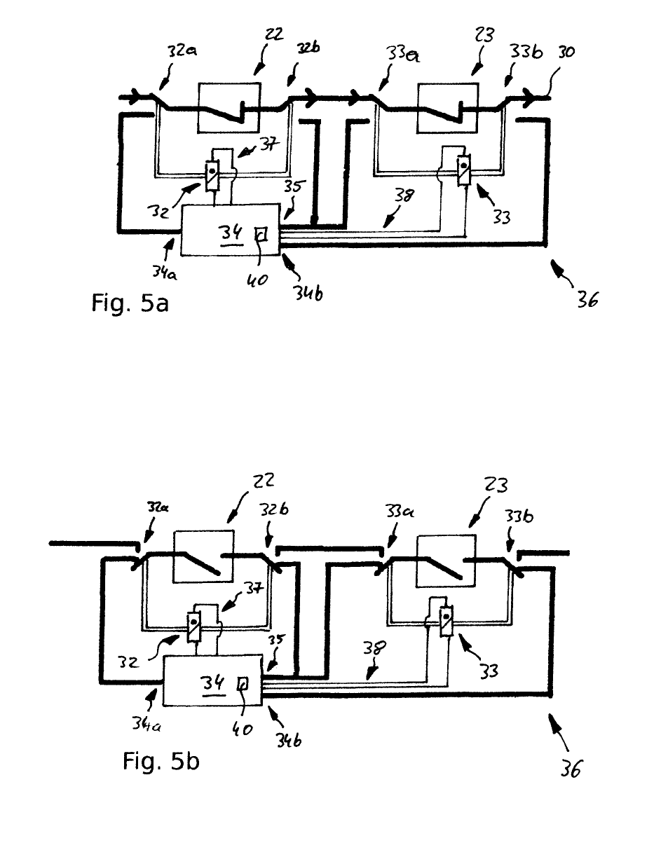

Such a unique identification is possible with the configuration of a testing arrangement 36 according to the fourth embodiment shown in FIGS. 5a and 5b. In said fourth embodiment the testing arrangement 36 comprises a plurality of relays 32, 33, wherein each of said relays 32, 33 individually connects the safety switches 22, 23, which are serially connected to the safety chain 30 in the operational mode (FIG. 5a), to the testing circuit 34 in the testing mode, as illustrated in FIG. 5b. In the configuration according to the fourth embodiment the testing circuit 34 needs to provide at least the same number of input terminals 34a, 34b as safety switches 22, 23 are present in the safety chain 30 and at least one common ground terminal 35. This configuration allows testing each of the safety switches 22, 23 individually and uniquely identifying a defect safety switch 22, 23 from the plurality of safety switches 22, 23 connected to the safety chain 30.

Usually all testing relays 32, 33 are driven simultaneously in order to simultaneously disconnect the safety switches 22, 23 from the safety chain 30 and to simultaneously connect the safety switches 22, 23 to the testing circuit 34 (FIG. 5a) and vice versa (FIG. 5b). However, providing individual electrical lines 37, 38 for individually connecting each testing relay 32, 33 to the testing circuit 34 allows to individually switch the connection of the safety switches 22, 23 from the safety chain 30 to the testing circuit 34, if this is necessary or desirable for running a specific test program. Alternatively, according to a modification which is not shown in the Figures, all testing relays 32, 33 may be driven be a common electrical line 37. Such a configuration does not allow driving the relays 32, 33 individually, but saves the costs for additional electrical lines 38.

Although not explicitly shown in the figures, the skilled person easily understands that the third and fourth embodiments shown in FIGS. 4a, 4b, 5a, and 5b may also be realized employing only a single testing relay 32 comprising a plurality of contact pairs 32a, 32b, 32c, 32d, as it is shown in FIGS. 3a, 3b. In this case, however, it is not possible to switch the safety switches 22, 23 individually from being electrically connected to the safety chain 30 to being electrically connected to the test circuit 34.

Although safety switches 22, 23 are shown in the figures, the skilled person easily understands that the disclosed testing arrangements 36 may be employed for testing all kind of safety sensors 21, 22, 23, 26, 28 connected to the safety chain 30, in particular including at least one of a maintenance door switch 21, a landing door switch 22, a car door switch 23, a motor sensor 26 and a brake sensor 28 and any combination thereof.

### FURTHER EMBODIMENTS

A number of optional features are set out in the following. These features may be realized in particular embodiments, alone or in combination with any of the other features.

In an embodiment of the testing arrangement the at least one test circuit comprises a microprocessor which is configured for testing the at least one safety sensor and/or for driving the at least one testing relay. A microprocessor allows a reliable testing of the at least one safety sensor by running an appropriate test program. Employing a microprocessor further allows an easy update of the test procedures by changing or modifying the test program.

In an embodiment of the testing arrangement the testing relay is a security relay comprising positively driven contacts in order to reliably avoid an undefined state of the relay's contacts. This enhances the operational safety of the testing arrangement and the safety chain even further.

In an embodiment the safety system comprises a plurality of safety sensors which are serially connected to the safety chain when the at least one testing relay is switched to its operational position. Each of the safety sensors may be located at and/or associated with at least one of the doors. This reliably avoids any unsafe operation of the elevator system, in particular any movement of the elevator car when at least one of the doors is not completely closed.

In an embodiment the plurality of safety sensors are serially connected to the test circuit when the at least one testing relay is switched into the test position. This configuration allows an easy and economically testing of all safety sensors with only a single test circuit.

In an embodiment the plurality of safety sensors are connected to the test circuit in parallel when the at least one testing relay is switched to the test position. This configuration allows a unique identification of a defect safety sensor as all safety sensors may be tested individually.

In an embodiment the at least one safety sensor includes a car door switch in order to reliably avoid that the elevator system is operated, in particular that the elevator car is moved, when at least one of the car doors is not completely closed.

In an embodiment the at least one safety sensor includes a landing door switch in order to reliably avoid that the elevator system is operated, in particular that the elevator car is moved, when at least one of the landing doors is not completely closed.

In an embodiment the at least one safety sensor includes a maintenance door switch in order to reliably avoid that the elevator system is operated, in particular that the elevator car is moved, when at least one maintenance door providing access to the hoistway and/or a machine room, which is provided for housing the elevator drive, is not completely closed.

In an embodiment the at least one safety sensor includes a motor sensor and/or a brake sensor for ensuring a safe operation of the motor and the brake, respectively.

In an embodiment the testing arrangement comprises a single testing relay with a plurality of switchable contacts, the testing relay being capable to switch a plurality of safety contact from being connected to the safety chain to being connected with the test circuit. This allows to provide a testing arrangement allowing testing of a plurality of safety sensors with only one testing relay.

In an embodiment the safety system comprises a plurality of safety sensors and a plurality of testing relays, in particular the same number of testing relays as safety sensors, wherein each testing relay is associated with a corresponding safety sensor. This configuration allows individually switching each safety sensor between being connected to the safety chain and being connected to the testing circuit.

In an embodiment the at least one safety sensor is disconnected from the safety chain and connected to the test circuit when the elevator car has stopped at a landing and the car doors have been opened. This allows testing the safety sensor(s) without interrupting the elevator's operation.

In an embodiment the at least one safety sensor is disconnected from the safety chain and connected to the test circuit for testing the operability of the safety sensor every time the car has stopped at a landing providing a periodic testing of the safety sensors in order to ensure their operational safety at all times.

In an embodiment disconnecting the at least one safety sensor from the safety chain and connecting the at least one safety sensor to a test circuit is done simultaneously by operating at least one testing relay. This enhances the operational safety, as it is reliably avoided that the at least one safety sensor is connected to the safety chain and test circuit at the same time.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention not be limited to the particular embodiment disclosed, but that the invention include all embodiments falling within the scope of the dependent claims.

### REFERENCES

1 elevator system
2 hoistway
3 pit
4 floor
5 input unit
6 hoistway door
8 elevator car
10 tension member
12 elevator drive
14 elevator control unit
16 car door
17 diagnostic unit
18 motor
20 brake
21 safety sensor/maintenance door switch
22 safety sensor/landing door switch
23 safety sensor/car door switch
24 positional sensor
25 maintenance door
26 safety sensor/motor sensor
28 safety sensor/brake sensor
30 safety chain
32, 33 testing relay
32a, 32b, 32c, 32d, 33a, 33b contacts of the testing relay
34 test circuit
34a, 34b input terminals of the test circuit
35 ground terminal
36 testing arrangement
37, 38 electrical line
40 microprocessor

1. A testing arrangement (36) for testing the operability of at least one safety sensor (21, 22, 23, 26, 28) connected to a safety chain (30) of an elevator system (1), the testing arrangement (36) comprising:
at least one test circuit (34) for testing the operability of the at least one safety sensor (21, 22, 23, 26,28); and
at least one testing relay (32, 33) being switchable between an operational position and a test position and which is configured for electrically connecting the at least one safety sensor (21, 22, 23, 26, 28) to the safety chain (30) in the operational position and for electrically connecting the at least one safety sensor (21, 22, 23, 26, 28) to the test circuit (34) in the test position.

2. The testing arrangement (36) of claim 1, wherein the at least one test circuit (34) comprises a microprocessor (40) which is configured for testing the at least one safety sensor (21, 22, 23, 26, 28).

3. The testing arrangement (36) of claim 1, wherein the at least one test circuit (34) is configured for driving the at least one testing relay (32, 33).

4. The testing arrangement (36) of claim 3, wherein the at least one test circuit (34) comprises a microprocessor (40) which is configured for driving the at least one testing relay (32, 33).

5. The testing arrangement (36) of claim 1, wherein the testing relay (32, 33) comprises a plurality of switchable contacts (32a, 32b, 32c, 32d).

6. The testing arrangement (36) of claim 1, wherein the testing relay (32, 33) is a security relay comprising positively driven contacts (32a, 32b, 32c, 32d, 33a, 33b).

7. A safety system of an elevator system (1) comprising:
a safety chain (30) including at least one safety sensor (21, 22, 23, 26, 28);
and
a testing arrangement (36) according to claim 1.

8. The safety system of claim 7 comprising a plurality of safety sensors (21, 22, 23, 26, 28) which are connected within the safety chain (30) when the at least one testing relay (32, 33) is switched to its operational position, wherein the safety sensors (21, 22, 23, 26, 28) are in particular serially connected within the safety chain (30).

9. The safety system of an elevator system (1) of claim 8, wherein the plurality of safety sensors (21, 22, 23, 26, 28) are serially connected to the test circuit (34) when the at least one testing relay (32, 33) is switched to its test position.

10. The safety chain (30) of an elevator system (1) of claim 8, wherein the plurality of safety sensors (21, 22, 23, 26, 28) are connected to the test circuit (34) in parallel when the at least one testing relay (32, 33) switched to its test position.

11. The safety system of an elevator system (1) of claim 7, wherein the at least one safety sensor (21, 22, 23, 26, 28) includes at least one of a car door switch (23), a landing door switch (22), a maintenance door switch (21), a motor sensor (26) and a brake sensor (28).

12. The safety system of an elevator system (1) of claim 7 comprising a plurality of safety sensors (21, 22, 23, 26, 28) and a plurality testing relays (32, 33), in particular the same number of testing relays (32, 33) as safety sensors (21, 22, 23, 26, 28).

13. A method for testing the operability of at least one safety sensor (21, 22, 23, 26, 28) in a safety chain (30) of an elevator system (1), the method comprising:
disconnecting the at least one safety sensor (21, 22, 23, 26, 28) from the safety chain (30); and
connecting the at least one safety sensor (21, 22, 23, 26, 28) to a test circuit (34) which is configured to testing the operability of the at least one safety sensor (21, 22,23, 26, 28).

14. The method of claim 13, wherein
the elevator system (1) comprises at least one elevator car (8), and
the at least one safety sensor (21, 22, 23, 26, 28) is disconnected from the safety chain (30) and connected to the test circuit (34) when the elevator car (8) has stopped at a landing (4) and a at least one elevator car door (16) and at least one hoistway door (16) have been opened, wherein the at least one safety sensor (21, 22, 23, 26, 28) in particular is disconnected from the safety chain (30) and connected to a test circuit (34) for testing the operability of the at least one safety sensor (21, 22, 23, 26, 28) every time the elevator car (8) has stopped at a landing (4).

15. The method of claim 13, wherein disconnecting the at least one safety sensor (21, 22, 23, 26, 28) from the safety chain (30) and connecting the at least one safety sensor (21, 22, 23, 26, 28) to a test circuit (34) is done simultaneously by operating a testing relay (32, 33).
